(19) United States
(12) Patent Application Publication
(10) Pub. No.: US 2026/0164516 A1
(43) Pub. Date: Jun. 11, 2026

(54) ELEMENT OF AN INDUCTION HEATING APPARATUS SUITABLE FOR RECEIVING A COOLANT

(71) Applicant: FIVES CELES, LAUTENBACH (FR)

(72) Inventors: Tony KEZER, Lautenbach (FR); Frédéric RAVERDY, Burnhaupt-le-Haut (FR)

(21) Appl. No.: 18/717,472

(22) PCT Filed: Dec. 7, 2022
(86) PCT No.: PCT/EP2022/084844

§ 371 Date: Jun. 7, 2024

(30) Foreign Application Priority Data
Dec. 7, 2021 (FR) FR2113050

(51) Int. Cl. H05B 6/42

(52) U.S. Cl. CPC H05B 6/42

(57) ABSTRACT

An element for use as a component of an induction heating apparatus, an oscillating circuit for forming an electromagnetic field for inductively heating a product, or an element placed in said electromagnetic field and through which a current induced by said electromagnetic field flows, comprising a first metal sheet and a second metal sheet, the two metal sheets being made of copper or a copper alloy, the first metal sheet at least partially covering a first large face of the second metal sheet, the two metal sheets being connected by a continuous peripheral weld forming a border inside which the metal sheets are mainly spaced apart and form a free space therebetween receives a circulating coolant and in that the mechanical resistance to plastic deformation of the first metal sheet is lower than that of the second metal sheet.

### DESIGNATION OF THE RELEVANT TECHNICAL FIELD

The invention relates to induction heating apparatus and more particularly to elements of an oscillating circuit and to elements placed in the magnetic field generated by the oscillating circuit and through which a current induced by said magnetic field flows.

### TECHNICAL PROBLEMS ADDRESSED BY THE INVENTION AND TECHNICAL BACKGROUND

Induction heating apparatus comprise elements made of electrically conductive material, typically copper sheets whose thickness is generally between 0.5 and 5 mm, allowing electric currents to flow through. These metal sheets are notably used to form inductors, supply plates between a power source and an inductor, magnetic shields around an inductor, short circuit coils or plates at the ends of an inductor or heat sinks. As current densities are often very high, these elements must be cooled by a fluid in order to maintain a maximum acceptable temperature of around 80° C. The usual means of cooling these elements involves brazing a plurality of copper tubes, typically 16 mm in diameter, onto the copper sheet. This involves assembling a large number of parts, which reduces reliability with the risk of leakage or poor mechanical and thermal contact between the tube and metal sheet reducing the ability to dissipate heat.

The invention provides a solution to these problems with elements that limit the number of parts to be assembled, while optimizing heat dissipation by virtue of a more homogeneous distribution of the coolant. The invention thus makes it possible to optimize the sizing of the cooling systems and limit the presence of hot spots on elements of an induction heating apparatus.

### SUMMARY OF THE INVENTION

According to a first aspect of the invention, an element is proposed that is suitable for use as a component of an induction heating apparatus, in particular an element of an oscillating circuit for forming an electromagnetic field intended for inductively heating a product, or an element placed in said electromagnetic field and through which a current induced by said electromagnetic field flows, characterized in that it comprises a first metal sheet and a second metal sheet, the two metal sheets being made of copper or a copper alloy, the first metal sheet at least partially covering a first large face of the second metal sheet, the two metal sheets being connected by a continuous peripheral weld forming a border, inside which the metal sheets are mainly spaced apart and form a free space therebetween that is intended to receive a circulating coolant and in that the mechanical resistance to plastic deformation of the first metal sheet is lower than that of the second metal sheet to the extent that pressurization of the free space between the two metal sheets may cause plastic deformation of the first metal sheet without causing plastic deformation of the second metal sheet.

The element according to the invention forms a rigid and robust assembly suitable for receiving a coolant between the two metal sheets inside the border formed by the peripheral continuous weld. This element is simpler and less costly to manufacture than according to the prior art. There's also less risk of coolant leakage, for more distributed and more efficient cooling.

The element is capable of being passed through by an alternating electric current of any frequency, for example 80 KHz, without excessive heating due to the evacuation of the heat generated by the Joule effect by the coolant flowing between the metal sheets.

According to one variant of the invention, the element comprises a third metal sheet whose mechanical resistance to plastic deformation is lower than that of the second metal sheet, the third metal sheet being arranged on the second large face of the second metal sheet, the third metal sheet and the second metal sheet being connected by a continuous peripheral weld defining a border inside which the third metal sheet and the second metal sheet are mainly spaced apart and form a free space therebetween wherein a coolant can circulate.

This configuration enables the cooling capacity of the element to be increased, for example, it can be doubled.

When the element is a component of an oscillating circuit, a large electric current flows therethrough, the intensity of which depends on the power to be delivered. The higher the frequency of this current, the more the electric current flows and concentrates on the surface of the large opposite faces of the second thicker metal sheet. This results in greater heating of the two large opposite faces of the metal sheet, and less heating in the center of the metal sheet thickness. It is therefore advantageous to have an element that is cooled by the two large opposite faces of the thicker metal sheet, or that has the highest mechanical resistance.

According to one embodiment of the invention, the lower mechanical resistance to plastic deformation of the first metal sheet and/or of the third metal sheet results from a lower thickness of the first metal sheet, and/or of the third metal sheet, compared to the second metal sheet.

For the same metallurgical state of the metal sheets, a difference in thickness between the first and third metal sheets and the second metal sheet is selected such that only the first and third metal sheets plastically deform under the effect of the pressure of the fluid injected into the element until the desired shape is achieved. Thus, the main shape of the element is preserved despite the deformation of the thinner metal sheets due to the non-deformation of the thicker metal sheet.

The penetration depth ε of the electric current into the metal sheets of the element depends on the current frequency at which the oscillating circuit operates. This depth decreases when the frequency increases according to the formula below wherein f is the frequency of the oscillating circuit current, μ is the relative magnetic permeability of the metal sheet and σ is the electrical conductivity thereof:

$$ε = \frac{1}{\sqrt{π \cdot f \cdot μσ}}$$

The thicknesses of the metal sheets are selected such that the electric current flows preferentially through the thicker metal sheet. Since current flow is a function of the frequency thereof, the thinner the metal sheet, the lower the current flow and the higher the frequency. Below a certain frequency, for a given thickness, the current will not flow through this thinner metal sheet or only very slightly.

The first and third metal sheets may be of the same or different thicknesses. Advantageously, the two metal sheets arranged on either side of the second thicker metal sheet are of the same thickness. Using metal sheets of the same thickness facilitates welding operations, since the same welding conditions can be used to weld two thinner metal sheets. Furthermore, if the two metal sheets are welded simultaneously to the thicker metal sheet using the same weld, the use of metal sheets of the same thickness means that the same result can be achieved on both metal sheets, which might not be the case if the two metal sheets were of different thicknesses.

According to another embodiment of the invention, the lower mechanical resistance to plastic deformation of the first metal sheet and/or of the third metal sheet results from a different metallurgical state of the first metal sheet, and/or of the third metal sheet, compared to the second metal sheet, the first metal sheet and/or the third metal sheet being, for example, in an annealed state and the second metal sheet in a cold-worked state.

The difference in metallurgical state between the first and third metal sheets and the second metal sheet is selected such that only the first and third metal sheets are plastically deformed under the effect of the pressure of the fluid injected into the element until the desired shape is achieved. In this way, the main shape of the element is preserved despite the deformation of the less resistant metal sheets due to the non-deformation of the more resistant metal sheet. The first and third metal sheets may have the same mechanical resistance to plastic deformation or different resistances.

According to another embodiment of the invention, the lower mechanical resistance to plastic deformation of the first metal sheet and/or of the third metal sheet results from the combination of a lower thickness and a different metallurgical state of the first metal sheet, and/or of the third metal sheet, compared to the second metal sheet.

The thickness and metallurgical state of the first and third metal sheets compared with those of the second metal sheet are selected such that only the first and third metal sheets plastically deform under the effect of the pressure of the fluid injected into the element until the desired shape is achieved. Thus, the main shape of the element is preserved despite the deformation of the thinner metal sheets due to the non-deformation of the thicker metal sheet. The first and third metal sheets may be of different thicknesses. For example, the first metal sheet may be thicker than the third metal sheet but have a metallurgical state offering less mechanical resistance to deformation than that of the third metal sheet.

A metal sheet with a metallurgical state that is work-hardened has a higher mechanical resistance than an annealed metal sheet. The higher the level of work hardening, the higher the level of resistance. To facilitate plastic deformation of a work-hardened sheet, said sheet is subjected to recrystallization annealing by heating the sheet to a high temperature, for example 300 to 600° C., for a sufficient period of time, for example between 15 minutes and 6 hours. The level of mechanical resistance of an annealed metal sheet will depend on whether the annealing is complete or partial, that is on the annealing temperature and the holding time at this temperature.

Advantageously according to the invention, inside the border formed by the peripheral continuous weld, the first metal sheet and the second metal sheet and/or the third metal sheet and the second metal sheet are connected by a plurality of continuous and/or discontinuous welds.

With a homogeneous open free space between the two metal sheets due to the presence of the continuous peripheral weld, the flow of coolant is not channeled between the two metal sheets and heat dissipation is not optimal due to limited turbulence. The addition, according to the invention, of a plurality of continuous or discontinuous welds inside the border formed by the peripheral continuous weld has the effect of forming channels through which the coolant flows, thus enabling the coolant to be channeled and distributed over the entire surface of the element while creating hydraulic turbulence to increase the exchange coefficient and draw more heat away. The plurality of continuous or discontinuous welds thus improves the efficiency and distribution of cooling inside the border formed by the peripheral continuous weld. These welds are advantageously discontinuous such that there is no surface of the more resistant metal sheet that is not accessible to the coolant inside the border formed by the peripheral continuous weld, or to limit this surface not accessible to the coolant.

The plurality of continuous or discontinuous welds inside the peripheral continuous weld also helps to contain the deformation of the less resistant metal sheet. It gives greater rigidity to the deformed metal sheet and better mechanical strength to the element. It thus has higher mechanical resistance to deformation in the event of mechanical impact.

Advantageously, the three metal sheets are connected by the same peripheral continuous weld and the same continuous and/or discontinuous welds inside the border formed by the peripheral continuous weld.

A continuous weld is produced, for example, by two rotating rollers on the outer faces of the thin metal sheets, arranged opposite each other on either side of the element and supplied with current. The current flowing between the rollers melts and welds the metal sheets together. Each discontinuous weld is, for example, a spot weld, obtained for example by two rollers as described above or by two electrodes. The welds can also be produced, for example, by laser welding or by blending. They can also be produced by bonding. Note that in the case of bonding, the term “weld” used herein is not entirely appropriate.

Connecting the three metal sheets with a single weld limits the number of welds required to produce the element, thus reducing manufacturing time and costs. This also means that the element is symmetrical along the plane passing through the middle of the central metal sheet so that cooling is symmetrical on its two large faces.

Advantageously, the element has a flat or curved shape or a shape combining one or more flat parts and one or more curved parts.

The invention can easily be implemented for a wide variety of element shapes, thus allowing adaptation as required, for example, to the function and position of the element in the induction heating apparatus or to the geometry of the workpiece to be inductively heated.

According to a second aspect of the invention, an inductor for heating a product by induction is proposed, the inductor comprising a wall arranged opposite the product to be heated connected to a supply plate connected to a source of alternating current, wherein the wall of the inductor, and/or the supply plate, comprises an element according to the first aspect of the invention.

The inductor may be formed of a single element or an assembly of elements according to the invention. The assembly of elements may be advantageous for inductors of large dimensions or complex shapes. The elements may all be identical or they may be different in order to best suit the inductor's characteristics.

The two supply plates of an inductor are often identical. Each is advantageously formed of a single element according to the invention.

When an inductor wall comprises an element according to the invention with only two metal sheets, the first metal sheet being thinner and the second metal sheet thicker, the element forming all or part of the wall arranged opposite the product to be heated has its second thicker metal sheet facing the inside of the inductor.

By taking the path of least resistance, the electric current circulating in the inductor will preferentially flow through the thickest metal sheet of the element. It is thus said latter that generates most of the electromagnetic field to inductively heat the product. By placing the thinner metal sheet of the element on the outer face of the inductor, it does not interfere with the magnetic field produced by the thicker metal sheet towards the product to be heated.

According to a third aspect of the invention, an induction heating apparatus is proposed comprising an inductor according to the second aspect of the invention and a magnetic shield around the inductor, wherein said magnetic shield comprises an element according to the first aspect of the invention.

A magnetic shield around the inductor prevents the magnetic field from heating metal parts in the vicinity of the inductor, particularly the framework supporting the heating equipment. According to the invention, when the magnetic shielding element is composed of metal sheets of different thicknesses, the thickest metal sheet of the element is placed opposite the source of the magnetic field, that is, towards the product to be heated, in order to promote the circulation of the magnetic field in the thickest metal sheet.

A short circuit coil or plate channels the magnetic field as close as possible to the inductor. Like magnetic shielding, it prevents the magnetic field from extending over a larger volume and from heating metal parts in the vicinity of the inductor. There are usually two short circuit coils or plates, one at each end of the inductor in a first direction. As the short circuit coils or plates are placed in the magnetic field generated by the inductor, electric currents are induced in the coils or plates which requires them to be cooled. According to the prior art, short circuit coils or plates are formed by copper metal sheets onto which copper tubes are welded, through which a coolant flows.

The induction heating apparatus according to the invention may comprise an inductor having at least one short circuit coil or plate wherein said short circuit coil or plate comprises an element according to the first aspect of the invention. For the same reasons as for the inductor, it is thus advantageous to form the short circuit coils or plates with elements according to the invention.

The induction heating apparatus according to the invention may comprise a heat sink. As the name implies, the function of a heat sink is to evacuate the heat. It is therefore a part that requires cooling. There are several models to choose from, depending on where they are positioned, for example on magnetic cylinder heads. According to the prior art, a heat sink comprises a copper part designed to draw heat away from the device to be cooled, to which a copper tube is soldered, through which the coolant circulates. For the same reasons as for the inductor, it is advantageous to form the heat sinks with elements according to the invention. Thus, the induction heating apparatus according to the invention may comprise a heat sink, wherein said heat sink comprises an element according to the invention.

According to a fourth aspect of the invention, a process is proposed for manufacturing an element according to the first aspect of the invention, wherein the free space formed between the first and/or third metal sheet and the second metal sheet is obtained by plastic deformation of the first and/or third metal sheet resulting from the injection of a pressurized fluid between the two metal sheets inside the border formed by the peripheral continuous weld.

Injecting a pressurized fluid between two metal sheets deforms the metal sheet that has a lower mechanical resistance to plastic deformation, for example because it is thinner or due to its metallurgical state.

Injecting a pressurized fluid has the advantage of distributing the pressure exerted by the fluid inside the border formed by the peripheral continuous weld. Thus, the coolant distribution channels formed by the deformation of the metal sheet can easily be the same size over the entire surface, according to the distribution of welds inside the border formed by the peripheral continuous weld. It is also possible to simply modify the dimensions of the distribution channels on the surface of the element, for example to enhance cooling in a particular zone thereof, by having a different distribution of continuous or discontinuous welds in this zone.

It should be noted that without the continuous or discontinuous welds inside the border formed by the peripheral continuous weld, the deformation of the thinner metal sheet obtained by a pressurized fluid would have the effect of moving the two metal sheets further apart in the center of the border formed by the peripheral continuous weld. The thickness of the element would increase, which may be a disadvantage for configurations where compactness is required. In addition, the rigidity and mechanical resistance to plastic deformation of the element in the event of mechanical impact would be lower.

Depending on its thickness, the initial metallurgical state of the first or third metal sheet may not be suitable such that the metal sheet may be deformed with the desired pressure level of fluid injected to achieve the deformation. According to the invention, annealing of the first and/or third metal sheet is carried out on at least the part of the metal sheet located, or intended to be located, inside the border formed by the peripheral continuous weld that is to be plastically deformed by the injection of a pressurized fluid.

This annealing reduces the mechanical resistance of the metal sheet to a level allowing it to be deformed. Annealing can be carried out on the entire metal sheet before it is welded to the second metal sheet.

Alternatively, annealing can be carried out only on the part to be plastically deformed. This localized annealing can be performed before the metal sheet is welded to the second metal sheet, or after the peripheral continuous weld is produced.

According to one embodiment of the invention, annealing is performed after the peripheral continuous weld has been produced, with the metal sheet being heated to the annealing temperature by the means used to produce the peripheral continuous weld and/or a continuous or discontinuous weld inside the border formed by the peripheral continuous weld, or by any other means.

When the welding means is suitable, for example that used for laser welding, it may be advantageous to apply the heat required for annealing with the welding means directly to the surface of the metal sheet to be deformed. The welding means may also allow the surface of the metal sheet to be heated in order to further lower the mechanical resistance of an already annealed, or partially annealed, metal sheet to promote the deformation thereof.

### BRIEF DESCRIPTION OF THE FIGURES

Further features and advantages of the invention will become apparent from the following detailed description, which can be understood with reference to the accompanying drawings, wherein:

FIG. 1 is a schematic front view of an element according to a first embodiment of the invention;

FIG. 2 is a schematic front view of an element according to a second embodiment of the invention;

FIG. 3 is a schematic front view of an element according to a third embodiment of the invention;

FIG. 4 is a schematic front view of an element according to a fourth embodiment of the invention;

FIG. 5 is a schematic cross-sectional side view of the element shown in FIG. 1;

FIG. 6 is a schematic cross-sectional side view of the element according to one embodiment of the invention;

FIG. 7 is a schematic cross-sectional view of an example of induction heating apparatus of a flat product according to one embodiment of the invention;

FIG. 8 is a schematic cross-sectional view of an example of induction heating apparatus of a cylindrical product according to one embodiment of the invention;

FIG. 9 is a front view of an inductor for heating a flat product comprising short circuit coils according to one embodiment of the invention;

FIG. 10 is a front view of an inductor for heating a flat product comprising short circuit plates according to one embodiment of the invention, and;

FIG. 11 is a front view of a heat sink according to one embodiment of the invention.

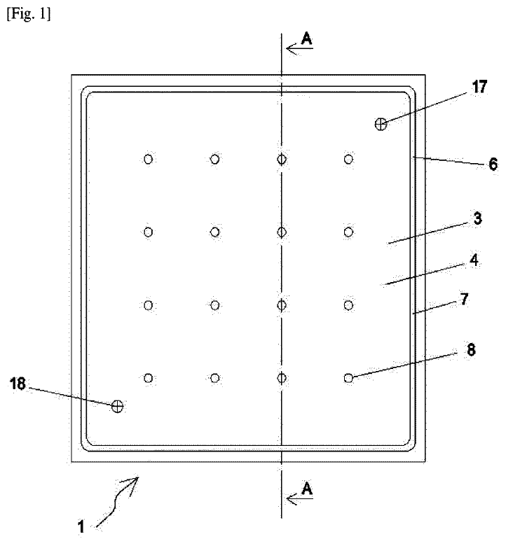

Referring to the diagram in FIG. 1, a schematic front view of an element according to a first embodiment of the invention can be seen. It is formed of metal sheets 3, 4, stacked such that only one metal sheet can be seen in this figure. They are connected by a continuous weld 6 around the periphery thereof to maximize the surface area inside the border 7 formed by the continuous weld. Inside this border, discontinuous welds 8 connecting the two metal sheets 3, 4 are present in a regular mesh. Discontinuous welds herein are spot welds. Two ducts, one 17 for supply and the other 18 for discharge, allow a coolant to flow between the two metal sheets. These ducts may be located on the same metal sheet, as shown in FIG. 1, or be arranged on different metal sheets.

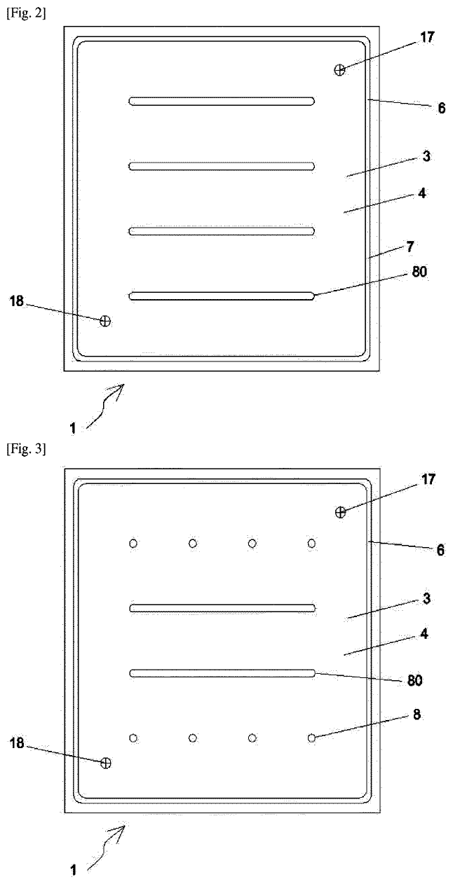

Referring to the diagram in FIG. 2, a schematic front view of an element according to a second embodiment of the invention can be seen. It differs from the first example in that it has discontinuous linear welds 80.

Referring to the diagram in FIG. 3, a schematic front view of an element according to a third embodiment of the invention can be seen, wherein discontinuous linear welds 80 and discontinuous spot welds 8 are combined.

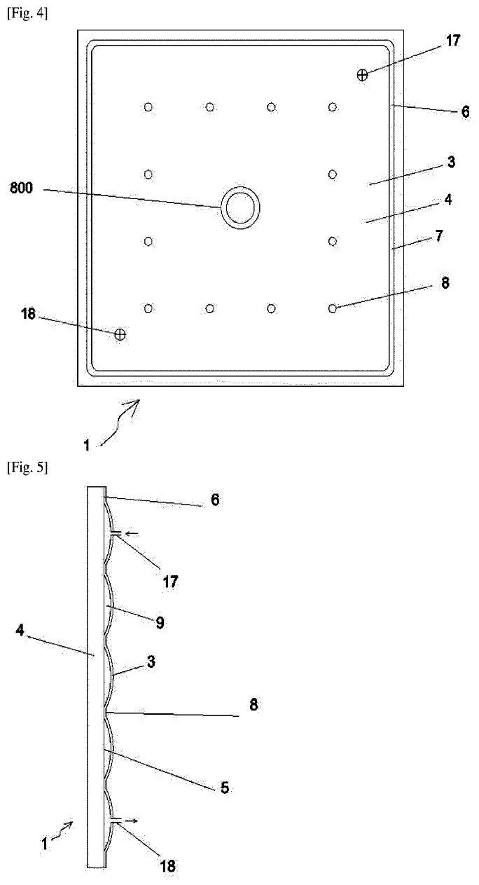

Referring to the diagram in FIG. 4, a schematic front view of an element according to a fourth embodiment of the invention can be seen wherein, inside the peripheral continuous weld 6, discontinuous spot welds 8 and a continuous weld 800 are combined. The continuous weld 800 may, for example, have the function of providing mechanical reinforcement at the location of the element on which it is produced. According to another example, it may be used to prevent the presence of coolant inside the surface it delimits.

The nature and position of the continuous and/or discontinuous welds arranged inside the border 7 formed by the peripheral continuous weld influence the flow of the coolant and the mechanical resistance of the element. Depending on the function of the element and its location in the inductor or heating apparatus, it is possible to select the nature and position of the continuous and/or discontinuous welds inside the border formed by the peripheral continuous weld.

Referring to the diagram in FIG. 5, a schematic cross-sectional side view of the element in FIG. 1 can be seen, along sectional plane AA passing through discontinuous welds shown in FIG. 1. The first thinner metal sheet 3 is arranged on the side of a large face 5 of the thicker metal sheet 4. Between the welds, metal sheet 3 has been moved away from this face 5 in order to create a free space 9 between the two metal sheets by injecting a fluid between the two metal sheets, the pressure of which has been chosen notably according to the mechanical resistance to deformation thereof, as well as the desired level of deformation for the thinner metal sheet.

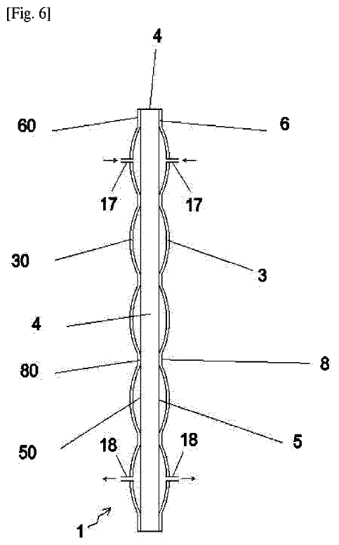

Referring to the diagram in FIG. 6, a schematic cross-sectional side view of an element similar to FIG. 5 can be seen, but according to an embodiment of the invention wherein the element comprises two thinner metal sheets 3, 30, one on each side 5, 50 of the thicker metal sheet 4. In this example, the two thinner metal sheets have the same thickness. However, the two thinner metal sheets may be different, for example having a greater thickness on one side of the element if greater mechanical resistance is desired on said side, or if the metal sheet on said side has lower mechanical resistance than that on the other side of the thicker metal sheet 4.

In the example shown in FIG. 6, continuous welds 6, 60 and discontinuous welds 8, 80 are positioned opposite each other. This may, for example, enable the three metal sheets to be joined by a single weld. Continuous and/or discontinuous welds can also be staggered between the two large faces of the thicker metal sheet. For example, the welds can be staggered such that the thickest metal sheet is always in contact with the coolant for at least one of said faces over the height and width thereof.

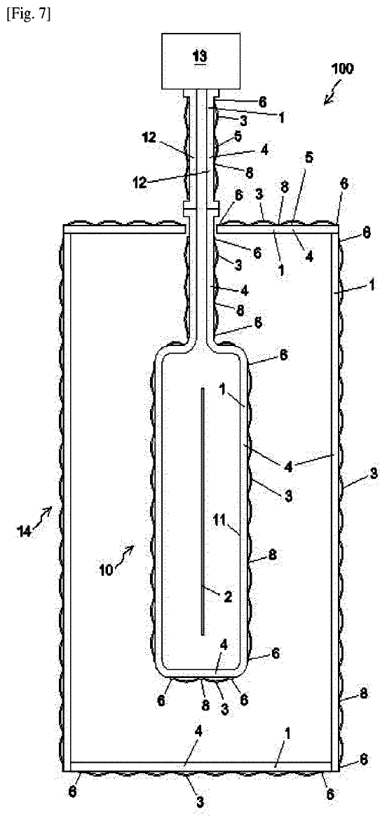

Referring to the diagram in FIG. 7, a schematic cross-sectional view of an example of induction heating apparatus can be seen for a flat product 2, herein a metal strip. It comprises an inductor 10 connected to a source 13 of alternating current by two supply plates 12, and a magnetic shield 14 around the inductor. The inductor, the supply plates and the magnetic shield are mainly formed of elements according to the invention, in its variant with a single thinner metal sheet.

According to one variant, only the inductor, and/or the supply plate, and/or the magnetic shield, or two of the three devices could be formed of elements according to the invention.

The elements forming the inductor have the thinner metal sheet thereof arranged outwardly from the center of the inductor where the product to be heated is located. The thickest metal sheet is thus placed where the current will tend to flow. Since the current flows preferentially through the thickest metal sheet, the magnetic field produced by the inductor is thus mainly generated by the thickest metal sheet. This arrangement makes product heating more efficient. Similarly, the elements forming the magnetic shield have a thinner metal sheet thereof arranged outwardly of the heating equipment in order to enhance the effectiveness of the magnetic shield. This is because the current generated by the magnetic field will flow on the inner side of the shield, therefore over the thickest metal sheet. This is also the case for short circuit coils or plates.

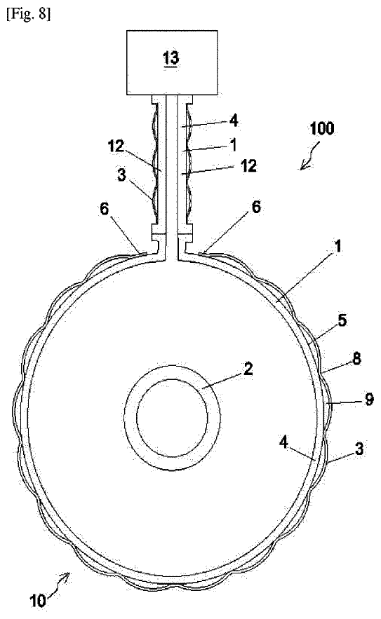

Referring to the diagram in FIG. 8, a schematic cross-sectional view of an example of induction heating apparatus can be seen according to the invention for a cylindrical product 2. The inductor 10 can advantageously only be formed by a single cylindrical element according to the invention.

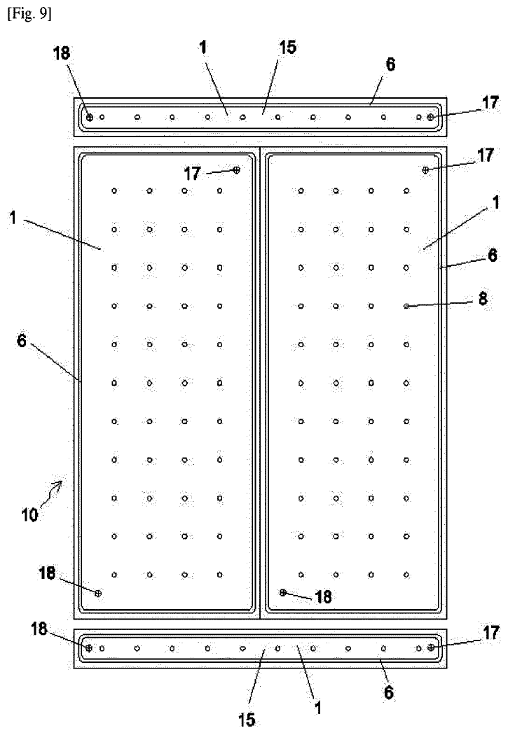

Referring to the diagram in FIG. 9, a front view of an inductor 10 can be seen with its two short circuit coils 15 for heating a flat product according to one embodiment of the invention. In this example, the large faces of the inductor are formed by two elements according to the invention, and those of the short circuit coils by a single element.

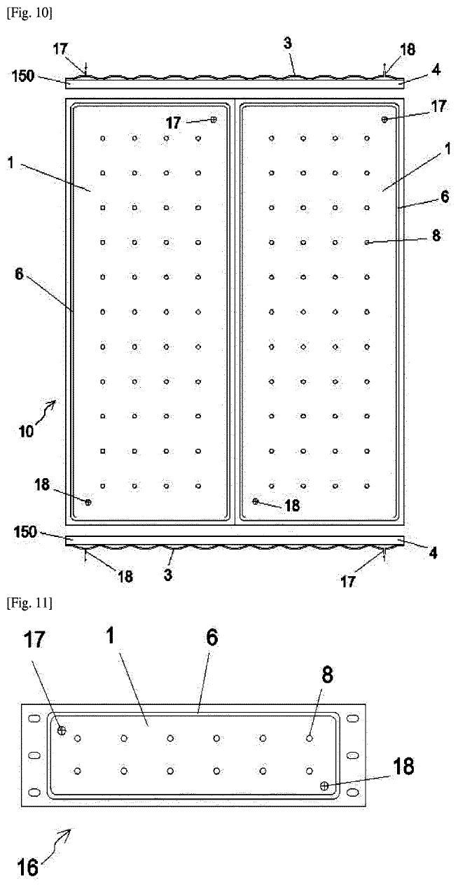

Referring to the diagram in FIG. 10, a front view can be seen of an inductor 10 similar to that of FIG. 9, but comprising two short circuit plates 150 instead of short circuit coils, according to one embodiment of the invention.

The inductor thus resembles a padded mattress, with bulges between the welds resembling those of a mattress between the stitches thereof.

Referring to the diagram in FIG. 11, an example of a heat sink 16 can be seen according to the invention, in a front view, formed by a single element.
1—Element according to the invention
2—Induction-heated product
3—First thinner metal sheet
30—Third thinner metal sheet
4—Second thicker metal sheet
5—First large face of the second metal sheet 4
50—Second large face of the second metal sheet 4
6—Continuous weld
60—Continuous weld
7—Border of the continuous weld
70—Border of the continuous weld
8—Discontinuous weld
80—Discontinuous weld
800—Continuous weld arranged inside the border 7 formed by the peripheral continuous weld 6, 60
9—Free space between the first and second metal sheets
90—Free space between the second and third metal sheets
10—Inductor
11—Inductor wall opposite the product 2
12—Supply plate of an inductor 10
13—Alternating current source
14—Magnetic shield
15—Short circuit coil
150—Short circuit plate
16—Heat sink
17—Coolant inlet
18—Coolant outlet
100—Heating apparatus

1. An element that is suitable for use as a component of an induction heating apparatus for inductively heating a product, in particular an element of an oscillating circuit for forming an electromagnetic field, or an element placed in said electromagnetic field and through which a current induced by said electromagnetic field flows, characterized in that it comprises a first metal sheet and a second metal sheet, the two metal sheets being made of copper or a copper alloy, the first metal sheet at least partially covering a first large face of the second metal sheet, the two metal sheets being connected by a continuous peripheral weld forming a border inside which the metal sheets are mainly spaced apart and form a free space therebetween that is intended to receive a circulating coolant and in that the mechanical resistance to plastic deformation of the first metal sheet is lower than that of the second metal sheet to the extent that pressurization of the free space between the two metal sheets may cause plastic deformation of the first metal sheet without causing plastic deformation of the second metal sheet.

2. The element according to claim 1, characterized in that it comprises a third metal sheet whose mechanical resistance to plastic deformation is lower than that of the second metal sheet, the third metal sheet being arranged on the second large face of the second metal sheet, the third metal sheet and the second metal sheet being connected by a continuous peripheral weld defining a border inside which the third metal sheet and the second metal sheet are mainly spaced apart and form a free space therebetween wherein a coolant can circulate.

3. The element according to claim 2, characterized in that the lower mechanical resistance to plastic deformation of the first metal sheet, and/or of the third sheet metal, results from a thinner first metal sheet, and/or third metal sheet, compared to the second metal sheet.

4. The element according to claim 2, characterized in that the lower mechanical resistance to plastic deformation of the first metal sheet, and/or of the third metal sheet, results from a different metallurgical state of the first metal sheet, and/or of the third metal sheet, compared to the second metal sheet, the first metal sheet and/or the third metal sheet being for example in an annealed state and the second metal sheet in a work-hardened state.

5. The element according to claim 2, characterized in that the lower mechanical resistance to plastic deformation of the first metal sheet, and/or of the third metal sheet, results from the combination of a thinner and a different metallurgical state of the first metal sheet, and/or of the third metal sheet, compared to the second metal sheet.

6. The element according to claim 2, characterized in that inside the border formed by the peripheral continuous weld, the first metal sheet and the second metal sheet and/or the third metal sheet and the second metal sheet are connected by a plurality of continuous and/or discontinuous welds.

7. The element according to claim 6, characterized in that the three metal sheets are connected by the same peripheral continuous weld and the same continuous and/or discontinuous welds inside the border formed by the peripheral continuous weld.

8. The element according to claim 2, characterized in that the two metal sheets arranged on either side of the second thicker metal sheet are of the same thickness.

9. The element according to claim 1, characterized in that it has a flat or curved shape or a shape combining one or more flat parts and one or more curved parts.

10. The element according to claim 1, being in communication with an inductor for inductively heating a product, the inductor comprising a wall arranged opposite the product to be heated connected to a supply plate connected to a source of alternating current, characterized in that the inductor wall, and/or the supply plate, comprises the element.

11. The element according to claim 10, comprising only two metal sheets, the first metal sheet being less thick than the second metal sheet, the element forming all or part of the wall arranged opposite the product to be heated, characterized in that the second thicker metal sheet is arranged towards the inside of the inductor where the product to be heated will be arranged.

12. The element according to claim 10 in communication with an induction heating apparatus comprising the inductor and a magnetic shield around the inductor, characterized in that said magnetic shield comprises the element.

13. The element according to claim 12, wherein the inductor comprises a short circuit coil or plate, characterized in that said short circuit coil or plate comprises the element.

14. The element according to claim 12, comprising a heat sink, characterized in that said heat sink comprises the element.

15. A process for manufacturing the element according to claim 2, characterized in that the free space formed between the first and/or third metal sheet, and the second metal sheet is obtained by a plastic deformation of the first and/or third metal sheet resulting from the injection of a pressurized fluid between the two metal sheets inside the border formed by the continuous peripheral weld.

16. The process according to claim 15, characterized in that annealing of the first, and/or of the third metal sheet is carried out on at least part of the sheet located, or intended to be located, inside the border formed by the peripheral continuous weld to be plastically deformed by the injection of a pressurized fluid.

17. The process according to claim 16, characterized in that the annealing is carried out after the peripheral continuous weld has been produced, the metal sheet being heated to the annealing temperature by the means used to produce the peripheral continuous weld and/or a continuous or discontinuous weld inside the border formed by the continuous peripheral weld or by other heating means.
